(19) United States
(12) Patent Application Publication
(10) Pub. No.: US 2018/0039143 A1
(43) Pub. Date: Feb. 8, 2018

(54) Liquid Crystal Display Panel, TFT Substrate And Manufacturing Method For The Same

(71) Applicant: Shenzhen China Star Optoelectronics Technology Co. Ltd., Shenzhen, Guangdong (CN)

(72) Inventor: Sikun HAO, Shenzhen, Guangdong (CN)

(73) Assignee: Shenzhen China Star Optoelectronics Technology Co. Ltd., Shenzhen, Guangdong (CN)

(21) Appl. No.: 14/914,260

(22) PCT Filed: Jan. 28, 2016
(86) PCT No.: PCT/CN2016/072549

§ 371 Date: Feb. 25, 2016

(30) Foreign Application Priority Data
Jan. 5, 2016 (CN) 201610006482.0

(51) Int. Cl. G02F 1/1343; G02F 1/1368; G02F 1/1333; G02F 1/1362

(52) U.S. Cl. CPC G02F 1/134363; G02F 1/13439; G02F 1/136227; G02F 1/1368; G02F 1/133345; G02F 2201/121; G02F 2001/134318

(57) ABSTRACT

A manufacturing method of the TFT substrate is disclosed, and including forming a first metal layer on a base layer; forming a first insulation layer on the first metal layer; forming an active semiconductor layer on the first insulation layer; forming a second metal layer, wherein, the second metal layer includes a first common electrode layer; forming a second insulation layer on the second metal layer; forming a resin layer on the second insulation layer; forming an ITO layer on the resin layer, wherein, the ITO layer includes a second common electrode layer; wherein, the first common electrode layer and the second common electrode layer are respectively disposed corresponding to a light-transmissive region of the TFT substrate. Through above way, the present invention can increase the capacitance of the storage capacitor, avoid the problem of adding the capacitance of the storage capacitor to cause decreasing the aperture ratio.

### BACKGROUND OF THE INVENTION

### 1. Field of the Invention

The present invention relates to a liquid crystal technology, and more particularly to a liquid crystal display panel, a TFT substrate and a manufacturing method for the same.

### 2. Description of Related Art

A liquid crystal display panel is a most widely used flat display panel currently, and has become high resolution color display panels of various electronic devices such as mobile phone, personal digital assistant (PDA), digital camera, computer screen or notebook computer screen. Along with the development of the liquid crystal display panel, people propose higher requirements for the display quality, the exterior design and the low cost and the high transmittance.

An IPS (planar control) mode liquid crystal display panel can make an observer only to see a short axis of liquid crystal at any time. Therefore, picture observed at every angle does not exist too much difference. Accordingly, the viewing angle of the IPS mode liquid crystal display panel is perfectly improved. However, as shown in FIG. 1, in an internal structure of the IPS mode liquid crystal display panel, an ITO layer includes a pixel electrode layer 128 and a common electrode layer 129, and the pixel electrode layer 128 and the common electrode layer 129 are both disposed on a resin layer such that a capacitance of a storage capacitor is small so that a larger breakdown voltage is required to be broken through in order to affect the picture quality of the IPS mode liquid crystal display panel. Accordingly, in order to ensure the picture quality of the IPS mode liquid crystal display panel, the method of adding additional capacitance of the storage capacitor is usually used. However, the aperture ratio will decrease such that the transmittance rate of the IPS mode liquid crystal panel becomes low, and the picture quality of the IPS mode liquid crystal display panel is also affected.

In summary, a liquid crystal display panel, a TFT substrate and the manufacturing method for the same is necessary to be provided to solve the above problem.

### SUMMARY OF THE INVENTION

The technology problem mainly solved by the present invention is to provide a liquid crystal display panel, a TFT substrate and a manufacturing method for the same in order to avoid the problem of adding the capacitance of the storage capacitor to cause decreasing the aperture ratio.

In order to solve the above technology problem, one technology solution adopted by the present invention is: a manufacturing method for a TFT substrate, wherein, the method comprises: forming a first metal layer on a base layer; forming a first insulation layer on the first metal layer; forming an active semiconductor layer on the first insulation layer; forming a second metal layer, wherein, the second metal layer includes a drain electrode and a source electrode disposed on the active semiconductor layer and a first common electrode layer disposed on the first insulation layer; forming a second insulation layer on the second metal layer; forming a resin layer on the second insulation layer; forming an ITO layer on the resin layer, wherein, the ITO layer includes a second common electrode layer; wherein, the first common electrode layer and the second common electrode layer are respectively disposed corresponding to a light-transmissive region of the TFT substrate.

Wherein, the method further comprises: disposing a concave slot that reveals the second insulation layer on the resin layer, wherein, the concave slot is disposed corresponding to the light-transmissive region of the TFT substrate.

Wherein, the second common electrode layer disposed at the light-transmissive region of the TFT substrate is disposed on the concave slot.

Wherein, the ITO layer further includes a pixel electrode layer, and the pixel electrode layer is disposed at a non-transmissive region of the TFT substrate.

Wherein, the method further includes: the resin layer is provided with a via hole that reveals the second metal layer, wherein, the via hole is disposed corresponding to the non-transmissive region of the TFT substrate, and the pixel electrode layer is disposed on the via hole.

In order to solve above technology problem, a technology solution adopted by the present invention is: a TFT substrate, comprising: a base layer; a first metal layer; a first metal layer disposed on the base layer; a first insulation layer disposed on the first metal layer; an active semiconductor layer disposed on the first insulation layer; a second metal layer; a second insulation layer disposed on the second metal layer; a resin layer disposed on the second insulation layer; and an ITO layer disposed on the resin layer; wherein, the second metal layer includes a drain electrode and a source electrode disposed on the active semiconductor layer and a first common electrode layer disposed on the first insulation layer; the ITO layer includes a second common electrode layer; the first common electrode layer and the second common electrode layer are respectively disposed corresponding to a light-transmissive region of the TFT substrate.

Wherein, the resin layer is provided with a concave slot that reveals the second insulation layer, the concave slot is disposed corresponding to the light-transmissive region of the TFT substrate, and the second common electrode layer disposed at the light-transmissive region of the TFT substrate is disposed on the concave slot.

Wherein, the ITO layer further includes a pixel electrode layer, and the pixel electrode layer is disposed at a non-transmissive region of the TFT substrate.

Wherein, the resin layer is provided with a via hole that reveals the second metal layer, wherein, the via hole is disposed corresponding to the non-transmissive region of the TFT substrate, and the pixel electrode layer is disposed on the via hole.

Wherein, the resin layer is a planarization passivation layer.

Wherein, a depth of the concave slot and a capacitance of a storage capacitor is positive proportional.

In order to solve above technology problem, another technology solution adopted by the present invention is: a liquid crystal display panel, wherein, the liquid crystal display panel comprises a TFT substrate, and the TFT substrate comprises: a base layer; a first metal layer; a first metal layer disposed on the base layer; a first insulation layer disposed on the first metal layer; an active semiconductor layer disposed on the first insulation layer; a second metal layer; a second insulation layer disposed on the second metal layer; a resin layer disposed on the second insulation layer; and an ITO layer disposed on the resin layer; wherein, the second metal layer includes a drain electrode and a source electrode disposed on the active semiconductor layer and a first common electrode layer disposed on the first insulation layer; the ITO layer includes a second common electrode layer; the first common electrode layer and the second common electrode layer are respectively disposed corresponding to a light-transmissive region of the TFT substrate.

Wherein, the resin layer is provided with a concave slot that reveals the second insulation layer, the concave slot is disposed corresponding to the light-transmissive region of the TFT substrate, and the second common electrode layer disposed at the light-transmissive region of the TFT substrate is disposed on the concave slot.

Wherein, the ITO layer further includes a pixel electrode layer, and the pixel electrode layer is disposed at a non-transmissive region of the TFT substrate.

Wherein, the resin layer is provided with a via hole that reveals the second metal layer, wherein, the via hole is disposed corresponding to the non-transmissive region of the TFT substrate, and the pixel electrode layer is disposed on the via hole.

Wherein, the resin layer is a planarization passivation layer.

Wherein, a depth of the concave slot and a capacitance of a storage capacitor is positive proportional.

Wherein, the liquid crystal display panel is an IPS liquid crystal display panel.

The beneficial effects of the present invention are: comparing with the conventional technology, the manufacturing method of the TFT substrate of the present invention includes: forming a first metal layer on a base layer; forming a first insulation layer on the first metal layer; forming an active semiconductor layer on the first insulation layer; forming a second metal layer, wherein, the second metal layer includes a drain electrode and a source electrode disposed on the active semiconductor layer and a first common electrode layer disposed on the first insulation layer; forming a second insulation layer on the second metal layer; forming a resin layer on the second insulation layer; forming an ITO layer on the resin layer, wherein, the ITO layer includes a second common electrode layer; wherein, the first common electrode layer and the second common electrode layer are respectively disposed corresponding to a light-transmissive region of the TFT substrate. Through above way, the present invention can increase the capacitance of the storage capacitor, avoid the problem of adding the capacitance of the storage capacitor to cause decreasing the aperture ratio, increase the transmittance of the liquid crystal display panel, and effectively improve the picture quality of the liquid crystal display panel.

### BRIEF DESCRIPTION OF THE DRAWINGS

FIG. 1 is a schematic structural diagram of the liquid crystal display panel of the conventional art;

FIG. 2 is a schematic structural diagram of the liquid crystal display panel of the present invention; and

FIG. 3 is flow chart of the manufacturing method for a TFT substrate of the present invention.

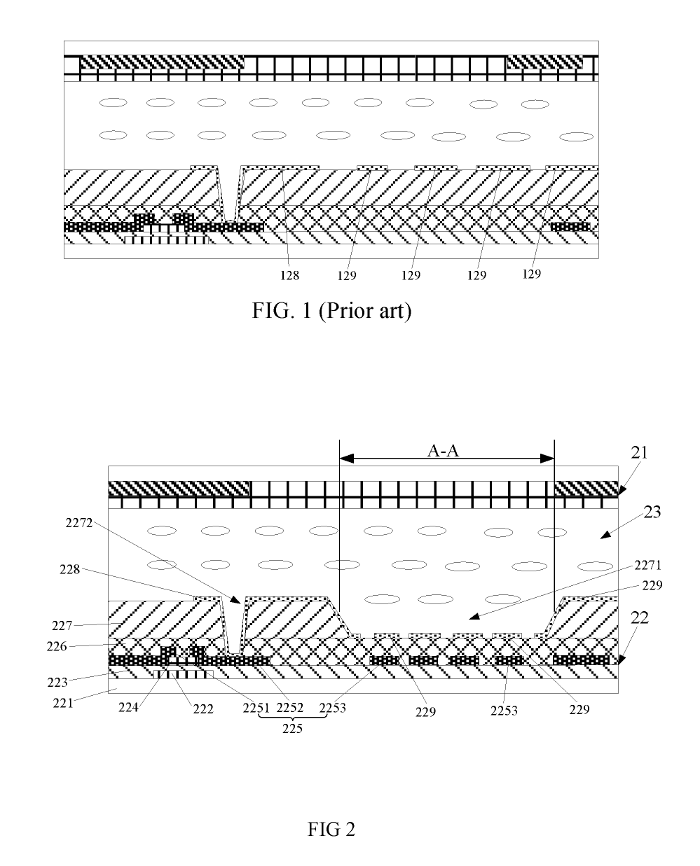

### DETAILED DESCRIPTION OF THE PREFERRED EMBODIMENT

The following will combine the figure and the embodiment to describe the present invention in detail.

The present invention discloses a display device, and the display device includes a liquid crystal display panel, wherein, the liquid crystal display panel is preferably an IPS mode liquid crystal display panel. Specifically, the liquid crystal display panel can adopt a first generation IPS technology that is a liquid crystal display panel having a new liquid crystal arrangement way provided for the disadvantages of the TN mode, which can realize a better viewing angle; the liquid crystal display panel can also adopt a second generation IPS technology (S-IPS, Super-IPS) that is a liquid crystal display panel using a “λ” shape electrode introducing a two-domain mode, which can improve a gray-inversion phenomenon at a specific angle of the liquid crystal display panel; the liquid crystal display panel can also adopt a third generation IPS technology (AS-IPS, Advanced Super-IPS) that increase the aperture ratio to obtain a higher brightness through decreasing distances among liquid crystal molecules.

As shown in FIG. 2, and FIG. 2 is a schematic structural diagram of the liquid crystal display panel of the present invention. A liquid crystal display panel includes a first substrate 21 and a second substrate 22 which are disposed at an interval and a liquid crystal layer 23 disposed between the first substrate 21 and the second substrate 22. In the present embodiment, the first substrate 21 is a CF substrate (color filter array), and the second substrate 22 is a TFT substrate (thin-film transistor array substrate).

The TFT substrate includes a base layer 221, a first metal layer 222, a first insulation layer 223, an active semiconductor layer 224, a second metal layer 225, a second insulation layer 226, a resin layer 227 and an ITO (conductive glass) layer (228, 229). The first metal layer 222 is disposed on the base layer 221, the first insulation layer 223 is disposed on the first metal layer 222, the active semiconductor layer 224 is disposed on the first insulation layer 223, the second metal layer 225 is respectively disposed on the active semiconductor layer 224 and the first insulation layer 223, the second insulation layer 226 is disposed on the second metal layer 225, the resin layer 227 is disposed on the second insulation layer 226, and the ITO layer (228, 229) is disposed on the resin layer 227.

Wherein, the second metal layer 225 includes a source electrode 2251, a drain electrode 2252 and a first common electrode layer 2253. The source electrode 2251 and the drain electrode 2252 are respectively disposed on the active semiconductor layer 224, the first common electrode layer 2253 is disposed on the first insulation layer 223. In the present embodiment, the first common electrode layer 2253 is disposed correspondingly to a light-transmissive region A-A of the TFT substrate.

The resin layer 227 is provided with a concave slot 2271 that reveals the second insulation layer 226, and a via hole 2272 that reveals the second metal layer 225. The concave slot 2271 is disposed correspondingly to the light-transmissive region A-A of the TFT substrate, that is, the concave slot 2271 is disposed at a location that corresponding to the light-transmissive region A-A of the liquid crystal display panel. The via hole 2272 is disposed corresponding to a non-transmissive region of the TFT substrate. Specifically, the resin layer 227 is a planarization passivation layer, that is, a polytetrafluoroethylene layer.

The ITO layer (228, 229) includes a pixel electrode layer 228 and a second common electrode layer 229. In the present embodiment, the second common electrode layer 229 is disposed corresponding to the light-transmissive region A-A of the TFT substrate. Specifically, the pixel electrode layer 228 is disposed at the non-transmissive region of the TFT substrate. One portion of the second common electrode layer 229 is disposed at the light-transmissive region of the TFT substrate, and another portion of the second common electrode layer 229 is disposed at the non-transmissive region of the TFT substrate. Preferably, the second common electrode layer 229 disposed at the transmissive region A-A of the TFT substrate is disposed on the concave slot 2271, and the pixel electrode layer 229 is disposed on the via hole 2272.

In the present embodiment, the first common electrode layer 2253 is multiple, and is disposed separately on the first insulation layer 223 corresponding to the light-transmissive region A-A. The second common electrode layer 229 is also multiple, and is disposed separately on the second insulation layer 226 corresponding to the light-transmissive region A-A. Wherein, the first common electrode layer 2253 and the second common electrode layer 229 are corresponding one by one. Of course, in another embodiment, the first common electrode layer 2253 and the second common electrode layer 229 are disposed correspondingly and are across.

It can be understood that the present invention is not limited to reveal the second insulation layer 226 through the concave slot 2271. In another embodiment, the concave slot will not pass through the resin layer 227, and a depth of the concave slot 2271 can be determined according to an actual requirement, which only requires to satisfy decreasing a distance between the first common electrode layer 2253 and the second common electrode layer 229. It should be noted that a depth of the concave slot 2271 is related to the capacitance of the storage capacitor of the liquid crystal display panel, that is, the depth of the concave slot 2271 and the capacitance of the storage capacitor is positive proportional. That is, when the depth of the concave slot 2271 is deeper, the capacitance formed between the first common electrode layer 2253 and the second common electrode layer 229 is larger such that the capacitance of the storage capacitor of the liquid crystal display panel is larger.

The present embodiment forms a new first common electrode layer 2253 through the second metal layer 225, and the new first common electrode layer 2253 form a new storage capacitor with the second common electrode layer 229 of the original ITO layer. Comparing to the conventional art, the present invention can increase the capacitance of the storage capacitor of the liquid crystal display panel. Furthermore, the present embodiment digs a hole to form the concave slot 2271 at the resin layer 227 corresponding to the light-transmissive region A-A, and the second common electrode layer 229 is disposed on the concave slot 2271 in order to reduce a distance between the first common electrode layer 2253 and the second common electrode layer 229 and further increase the capacitance of the storage capacitor. At the same time, a thickness of the resin layer 227 corresponding to the non-transmissive region is maintained to be unchanged, which will not affect the capacitance of the parasitic capacitor of the liquid crystal display panel.

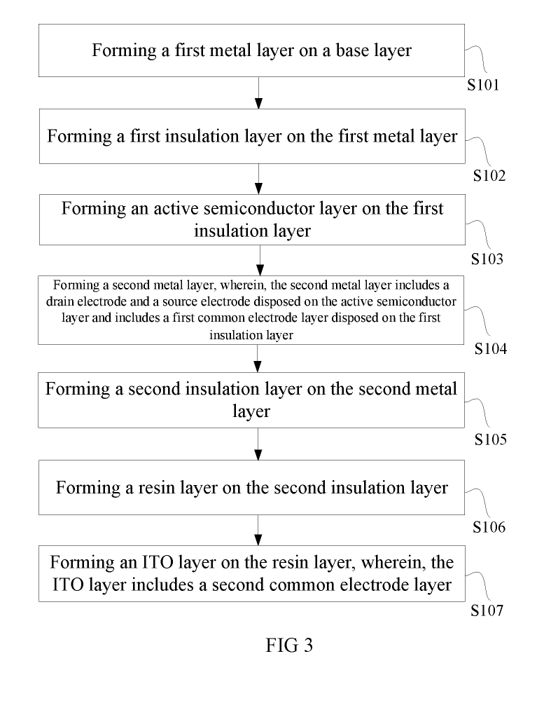

As shown in FIG. 3, FIG. 3 is flow chart of the manufacturing method for a TFT substrate of the present invention. The method includes following steps:

Step S101: forming a first metal layer 222 on a base layer 221.

Step S102: forming a first insulation layer 223 on the first metal layer 222.

Step S103: forming an active semiconductor layer 224 on the first insulation layer 223.

Step S104: forming a second metal layer 225, wherein, the second metal layer 225 includes a drain electrode 2252 and a source electrode 2251 disposed on the active semiconductor layer 224 and includes a first common electrode layer 2253 disposed on the first insulation layer 223.

It can be understood that, in a step S104, when forming the second metal layer 225, the second metal layer 225 is required to form the drain electrode 2252 and the source electrode 2251, and the second metal layer 225 is required to form the first common electrode layer 2253. Through the step of forming the second metal layer 225 to form the drain electrode 2252, the source electrode 2251 and the first common electrode layer 2253, the manufacturing cost can be saved.

Step S105: forming a second insulation layer 226 on the second metal layer 225.

Step S106: forming a resin layer 227 on the second insulation layer 226.

In the step S106, further including a step of disposing a concave slot 2271 that reveals the second insulation layer 226 on the resin layer 227. Wherein, the concave slot 2251 is disposed corresponding to the light-transmissive region A-A of the TFT substrate. It can be understood that the present invention is not limited to reveal the second insulation layer 226 through the concave slot 2271. In another embodiment, the concave slot will not pass through the resin layer 227, and a depth of the concave slot 2271 can be determined according to an actual requirement, which only requires to satisfy decreasing a distance between the first common electrode layer 2253 and the second common electrode layer 229. It should be noted that a depth of the concave slot 2271 is related to the capacitance of the storage capacitor of the liquid crystal display panel, that is, the depth of the concave slot 2271 and the capacitance of the storage capacitor is positive proportional. That is, when the depth of the concave slot 2271 is deeper, the capacitance formed between the first common electrode layer 2253 and the second common electrode layer 229 is larger such that the capacitance of the storage capacitor of the liquid crystal display panel is larger.

In the step S106, further including a step of disposing a via hole 2272 that reveals the second metal layer 225 on the resin layer 227. Wherein, the via hole 2272 is disposed corresponding to the non-transmissive region of the TFT substrate.

Step S107: forming an ITO layer (228, 229) on the resin layer 227, wherein, the ITO layer (228, 229) includes a second common electrode layer 229.

In the present embodiment, the second common electrode layer 229 disposed at the light-transmissive region A-A of the TFT substrate is disposed on the concave slot 2271. It can be understood that one portion of the second common electrode layer 229 is disposed at the light-transmissive region of the TFT substrate, and another portion of the second common electrode layer 229 is disposed at the non-transmissive region of the TFT substrate. Besides, the ITO layer (228, 229) further includes a pixel electrode layer 228, the pixel electrode layer 228 is disposed at the non-transmissive region of the TFT substrate, and the pixel electrode layer 228 is disposed on the via hole 2272.

The present embodiment forms a new first common electrode layer 2253 through the second metal layer 225, and the new first common electrode layer 2253 form a new storage capacitor with the second common electrode layer 229 of the original ITO layer. Comparing to the conventional art, the present invention can increase the capacitance of the storage capacitor of the liquid crystal display panel. Furthermore, the present embodiment digs a hole to form the concave slot 2271 at the resin layer 227 corresponding to the light-transmissive region A-A, and the second common electrode layer 229 is disposed on the concave slot 2271 in order to reduce a distance between the first common electrode layer 2253 and the second common electrode layer 229 and further increase the capacitance of the storage capacitor. At the same time, a thickness of the resin layer 227 corresponding to the non-transmissive region is maintained to be unchanged, which will not affect the capacitance of the parasitic capacitor of the liquid crystal display panel.

In summary, the manufacturing method of the TFT substrate of the present invention includes: forming a first metal layer on a base layer; forming a first insulation layer on the first metal layer; forming an active semiconductor layer on the first insulation layer; forming a second metal layer, wherein, the second metal layer includes a drain electrode and a source electrode disposed on the active semiconductor layer and a first common electrode layer disposed on the first insulation layer; forming a second insulation layer on the second metal layer; forming a resin layer on the second insulation layer; forming an ITO layer on the resin layer, wherein, the ITO layer includes a second common electrode layer; wherein, the first common electrode layer and the second common electrode layer are respectively disposed corresponding to a light-transmissive region of the TFT substrate. Through above way, the present invention can increase the capacitance of the storage capacitor, avoid the problem of adding the capacitance of the storage capacitor to cause decreasing the aperture ratio, increase the transmittance of the liquid crystal display panel, and effectively improve the picture quality of the liquid crystal display panel.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A manufacturing method for a TFT substrate, wherein, the method comprises:
forming a first metal layer on a base layer;
forming a first insulation layer on the first metal layer;
forming an active semiconductor layer on the first insulation layer;
forming a second metal layer, wherein, the second metal layer includes a drain electrode and a source electrode disposed on the active semiconductor layer and a first common electrode layer disposed on the first insulation layer;
forming a second insulation layer on the second metal layer;
forming a resin layer on the second insulation layer; and
forming an ITO layer on the resin layer, wherein, the ITO layer includes a second common electrode layer;
wherein, the first common electrode layer and the second common electrode layer are respectively disposed corresponding to a light-transmissive region of the TFT substrate.

2. The method according to claim 1, wherein, the method further comprises:
disposing a concave slot that reveals the second insulation layer on the resin layer, wherein, the concave slot is disposed corresponding to the light-transmissive region of the TFT substrate.

3. The method according to claim 2, wherein, the second common electrode layer disposed at the light-transmissive region of the TFT substrate is disposed on the concave slot.

4. The method according to claim 1, wherein, the ITO layer further includes a pixel electrode layer, and the pixel electrode layer is disposed at a non-transmissive region of the TFT substrate.

5. The method according to claim 4, wherein, the method further includes:
the resin layer is provided with a via hole that reveals the second metal layer, wherein, the via hole is disposed corresponding to the non-transmissive region of the TFT substrate, and the pixel electrode layer is disposed on the via hole.

6. A TFT substrate, comprising:
a base layer;
a first metal layer;
a first metal layer disposed on the base layer;
a first insulation layer disposed on the first metal layer;
an active semiconductor layer disposed on the first insulation layer;
a second metal layer;
a second insulation layer disposed on the second metal layer;
a resin layer disposed on the second insulation layer; and
an ITO layer disposed on the resin layer;
wherein, the second metal layer includes a drain electrode and a source electrode disposed on the active semiconductor layer and a first common electrode layer disposed on the first insulation layer; the ITO layer includes a second common electrode layer; the first common electrode layer and the second common electrode layer are respectively disposed corresponding to a light-transmissive region of the TFT substrate.

7. The TFT substrate according to claim 6, wherein, the resin layer is provided with a concave slot that reveals the second insulation layer, the concave slot is disposed corresponding to the light-transmissive region of the TFT substrate, and the second common electrode layer disposed at the light-transmissive region of the TFT substrate is disposed on the concave slot.

8. The TFT substrate according to claim 6, wherein, the ITO layer further includes a pixel electrode layer, and the pixel electrode layer is disposed at a non-transmissive region of the TFT substrate.

9. The TFT substrate according to claim 8, wherein, the resin layer is provided with a via hole that reveals the second metal layer, wherein, the via hole is disposed corresponding to the non-transmissive region of the TFT substrate, and the pixel electrode layer is disposed on the via hole.

10. The TFT substrate according to claim 6, wherein, the resin layer is a planarization passivation layer.

11. The TFT substrate according to claim 7, wherein, a depth of the concave slot and a capacitance of a storage capacitor is positive proportional.

12. A liquid crystal display panel, wherein, the liquid crystal display panel comprises a TFT substrate, and the TFT substrate comprises:
a base layer;
a first metal layer;
a first metal layer disposed on the base layer;
a first insulation layer disposed on the first metal layer;
an active semiconductor layer disposed on the first insulation layer;
a second metal layer;
a second insulation layer disposed on the second metal layer;
a resin layer disposed on the second insulation layer; and
an ITO layer disposed on the resin layer;
wherein, the second metal layer includes a drain electrode and a source electrode disposed on the active semiconductor layer and a first common electrode layer disposed on the first insulation layer; the ITO layer includes a second common electrode layer; the first common electrode layer and the second common electrode layer are respectively disposed corresponding to a light-transmissive region of the TFT substrate.

13. The liquid crystal display panel according to claim 12, wherein, the resin layer is provided with a concave slot that reveals the second insulation layer, the concave slot is disposed corresponding to the light-transmissive region of the TFT substrate, and the second common electrode layer disposed at the light-transmissive region of the TFT substrate is disposed on the concave slot.

14. The liquid crystal display panel according to claim 12, wherein, the ITO layer further includes a pixel electrode layer, and the pixel electrode layer is disposed at a non-transmissive region of the TFT substrate.

15. The liquid crystal display panel according to claim 14, wherein, the resin layer is provided with a via hole that reveals the second metal layer, wherein, the via hole is disposed corresponding to the non-transmissive region of the TFT substrate, and the pixel electrode layer is disposed on the via hole.

16. The liquid crystal display panel according to claim 12, wherein, the resin layer is a planarization passivation layer.

17. The liquid crystal display panel according to claim 13, wherein, a depth of the concave slot and a capacitance of a storage capacitor is positive proportional.

18. The liquid crystal display panel according to claim 12, wherein, the liquid crystal display panel is an IPS mode liquid crystal display panel.
